(19) United States
(12) Patent Application Publication
(10) Pub. No.: US 2024/0042247 A1
(43) Pub. Date: Feb. 8, 2024

(54) AIR FILTRATION MASK EXHALATION VALVE WITH ON/OFF CAPABILITY

(71) Applicant: James B. Schumacher, Tequesta, FL (US)

(72) Inventor: James B. Schumacher, Tequesta, FL (US)

(21) Appl. No.: 18/338,480

(22) Filed: Jun. 21, 2023

Related U.S. Application Data
(60) Provisional application No. 63/366,695, filed on Jun. 21, 2022.

(51) Int. Cl. A62B 9/02; A62B 7/10

(52) U.S. Cl. CPC A62B 9/02; A62B 7/10

(57) ABSTRACT

An exhalation valve, and air filtration mask with an exhalation valve, which can be changed from an ON position to an OFF position. The exhalation valve may comprise an upper component or member, illustrated herein as a valve cap, a lower component or member, illustrated herein as a valve base, and an intermediate component or member, positioned in between the valve cap and the valve base. The valve cap further includes an inner cap. An air passage component or member, illustrated herein as a diaphragm valve sits within the intermediate component or member.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/366,695, entitled “AIR FILTRATION MASK EXHALATION VALVE WITH ON/OFF CAPABILITY”, filed on Jun. 21, 2022. The contents of the above referenced application are incorporated herein by reference in its entirety.

### FIELD OF THE INVENTION

This invention is related to the field of air filtration face masks and respirators used to protect a wearer from pollutants and pathogens in the air, and those nearby from the wearer's exhaled droplets; more particularly, to air filtration face masks and respirators which contain an exhalation valve that can be turned on or off.

### BACKGROUND OF THE INVENTION

Fluid droplets excreted from humans are known to travel at least 6 feet, and can be a major driver of disease transmission. Individuals suffering from the flu can spread the disease to others up to about 6 feet away. According to the USA Center for Disease Control (CDC), approximately 5-20% of U.S. residents are infected with the seasonal flu each year. Furthermore, according to the World Health Organization (WHO), annual epidemics were thought to result in between three and five million cases of severe illness, and between 250,000 and 500,000 deaths every year around the world before COVID 19. COVID 19 greatly increased awareness in the benefit of the use of face coverings for reducing the spread of flu. Most deaths currently associated with influenza in industrialized countries occur among elderly individuals age 65 or older.

The use of masks and/or respirators is believed to be beneficial in minimizing disease transmission. A problem with respirators currently on the market is that they are fitted with exhalation valves that are only in the ON position or have no valve installed. The exhalation valve helps quickly expel the exhaled air so the mask is less hot, condensation does not build up, and most importantly, so the exhaled air can quickly evacuate the inside cavity of the mask so the wearer does not re-breathe exhaled air from the last breath. The use of the valve then makes the mask healthier for the wearer to increase their blood oxygen levels. However, if the wearer is infected with a communicable disease that can be transmitted by their breathing, coughing or sneezing droplets, an open valve allowing quick exhalation of the droplets could infect others nearby.

Current exhalation valves only allow for the valve to be ON, with some masks and respirators having no valve at all. Most respirators are sold with exhalation valves installed since they offer the most comfort and health benefit for the user. With no valve installed, respirators are useful in controlling the spread of disease if the wearer happens to be contagious. An ON/OFF exhalation valve allows for the best use for both the wearer and those around him/her. The invention may include a method to screw together the individual parts so the valve can be moved from a used filter to a new filter to reduce cost and waste, and help protect the environment. Alternatively, the new filter may be secured to the mask, via sonic welding.

A mask or respirator fitted with an exhalation valve that can be easily changed from ON to OFF allows the wearer to turn the valve ON when they are not in close proximity to others so they can breathe in the healthiest fashion possible, and the ability to turn the valve OFF when they are in close proximity to others, protecting them. Additionally, it is important that the valve has a recognizable marking showing others nearby that the valve is in the OFF position and that they are safe.

### SUMMARY OF THE INVENTION

Embodied is an exhalation valve, and air filtration mask with an exhalation valve, that can be easily changed from ON to OFF. The exhalation valve may comprise an upper component or member, illustrated herein as a valve cap, and lower component or member, illustrated herein as a valve base, and an intermediate component or member positioned in between the valve cap and the valve base. An air passage component or member, illustrated herein as a diaphragm valve, sits within the intermediate component or member. The exhalation valve allows a wearer to turn the valve ON when they are not in close proximity to others so they can breathe in the healthiest fashion possible, and the ability to turn the valve OFF when they are in close proximity to others, protecting them. The exhalation valve further allows a wearer going through the trouble of wearing a mask to be sure that the mask can work in the best fashion for their health, as well as protects those around them when in close proximity by simply adjusting the ON/OFF setting. Additionally, the exhalation valve may be configured to display a recognizable marking, showing others nearby that the valve is in the ON/OFF position.

Accordingly, it is a primary objective of the invention to provide an exhalation valve that can be traversed from an ON position to an OFF position.

It is a yet another objective of the invention to provide a mask and respirator that has an exhalation valve that can be used in an ON position or an OFF position.

It is a yet another objective of the invention to provide an exhalation valve that can be ON and allow for exhaled air to be quickly ventilated from inside the mask, forming the healthiest environment for the wearer.

It is a yet another objective of the invention to provide an exhalation valve which can also be moved to an OFF position, whereby exhaled air cannot escape and must pass through the filter to protect those in close proximity to the wearer from any possible contagion in the wearer's exhaled air.

It is a yet another objective of the invention to provide an exhalation valve that can be moved from one mask to another to reduce cost and waste, and protect the environment.

It is a yet another objective of the invention to provide an exhalation valve that is joined to a mask.

It is another objective of the invention to provide an exhalation valve that is sonic welded to a mask.

It is a yet another objective of the invention to provide an exhalation valve that can be attached to, secured to, or integrally formed to a material or substrate that filter air.

It is a further objective of the invention to provide an exhalation valve that clearly indicates on the valve whether the valve is in the ON or OFF position so that it is clearly visible to those in close proximity to the wearer.

It is a still further objective of the invention to provide an exhalation valve that can be used on many different styles of masks and respirators.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A is a perspective view of an illustrative example of an ON/OFF exhalation valve;

FIG. 1B is an alternative perspective view of the ON/OFF exhalation valve;

FIG. 1C is a bottom perspective view of the ON/OFF exhalation valve;

FIG. 2A is a top view of the exhalation valve, illustrated in the ON (or up) position;

FIG. 2B is a cross sectional view taken along lines A-A in FIG. 2A;

FIG. 2C is an enlarged view of the area under circle “C” illustrated in FIG. 2B;

FIG. 3A is a top view of the exhalation valve, illustrated in the OFF (or down) position;

FIG. 3B is a cross sectional view taken along lines B-B in FIG. 3A;

FIG. 3C is an enlarged view of the area under circle “D” illustrated in FIG. 3B;

FIG. 4 illustrates an air filtration mask with an ON/OFF exhalation valve;

FIG. 5 illustrates an individual wearing an air filtration mask with an ON/OFF exhalation valve;

FIG. 6 is an exploded view of the air filtration mask with an ON/OFF exhalation valve;

FIG. 7 is an alternative exploded view of the air filtration mask with an ON/OFF exhalation valve;

FIG. 8 is an alternative exploded view of the air filtration mask with an ON/OFF exhalation valve;

FIG. 9 is a perspective view of the cap valve;

FIG. 10 is a top view of the ON/OFF exhalation valve, illustrating the rotation to the OFF position, and with a portion of the top of the valve cap removed to see inside;

FIG. 11 is a perspective view of the ON/OFF exhalation valve shown in FIG. 10, illustrating the rotation to the OFF position;

FIG. 12 is a side view of the ON/OFF exhalation valve shown in FIG. 10, illustrating the rotation to the OFF position;

FIG. 13A is a perspective view of an illustrative example of an alternative embodiment of the ON/OFF exhalation valve;

FIG. 13B is an alternative perspective view of the ON/OFF exhalation valve shown in FIG. 13A;

FIG. 13C is a bottom perspective view of the ON/OFF exhalation valve shown in FIG. 13A;

FIG. 14A is a top view of the exhalation valve shown in FIG. 13A, illustrated in the ON (or up) position;

FIG. 14B is a cross-sectional view taken along lines 14B-14B in FIG. 14A;

FIG. 14C is an enlarged view of the area under circle “C” illustrated in FIG. 14B;

FIG. 15A is a top view of the exhalation valve shown in FIG. 13A, illustrated in the OFF (or down) position;

FIG. 15B is a cross-sectional view taken along lines 15B-15B in FIG. 15A;

FIG. 15C is an enlarged view of the area under circle “D” illustrated in FIG. 15B;

FIG. 16 illustrates an air filtration mask with the ON/OFF exhalation valve;

FIG. 17 illustrates an individual wearing an air filtration mask with the ON/OFF exhalation valve;

FIG. 18 is an exploded view of the air filtration mask with an ON/OFF exhalation valve illustrated in FIG. 13A;

FIG. 19 is an alternative exploded view of the air filtration mask with an ON/OFF exhalation valve illustrated in FIG. 13A;

FIG. 20 is an alternative exploded view of the air filtration mask with an ON/OFF exhalation valve illustrated in FIG. 13A;

FIG. 21 is a perspective view of the valve cap, with the inner cap secured thereto;

FIG. 22A is a top perspective view of the valve base;

FIG. 22B is a bottom perspective view of the valve base;

FIG. 23A is a top view of the ON/OFF exhalation valve, illustrating the rotation to the ON position (from the OFF position);

FIG. 23B is a perspective view of the ON/OFF exhalation valve shown in FIG. 23A, illustrating the rotation to the ON position;

FIG. 23C is a side view of the ON/OFF exhalation valve shown in FIG. 23A, illustrating the rotation to the ON position;

FIG. 23D is a side view of the ON/OFF exhalation valve shown in FIG. 23A, illustrating the ON position;

FIG. 24A is a top view of the ON/OFF exhalation valve, illustrating the rotation to the OFF position (from the ON position);

FIG. 24B is a perspective view of the ON/OFF exhalation valve shown in FIG. 24A, illustrating the rotation to the OFF position; and

FIG. 24C is a side view of the ON/OFF exhalation valve shown in FIG. 24A, illustrating the rotation to the OFF position; and

FIG. 24D is a side view of the ON/OFF exhalation valve shown in FIG. 24A, illustrating the OFF position;

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

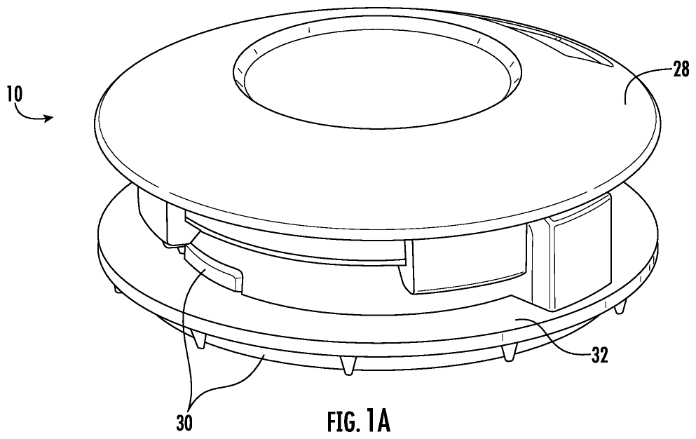

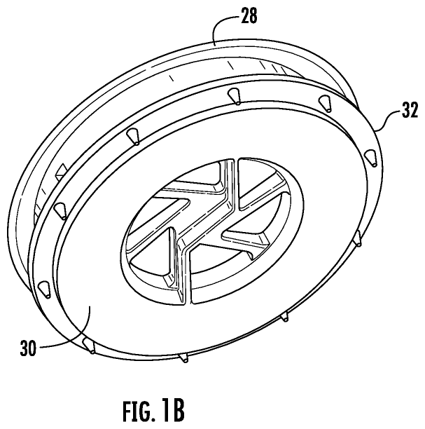

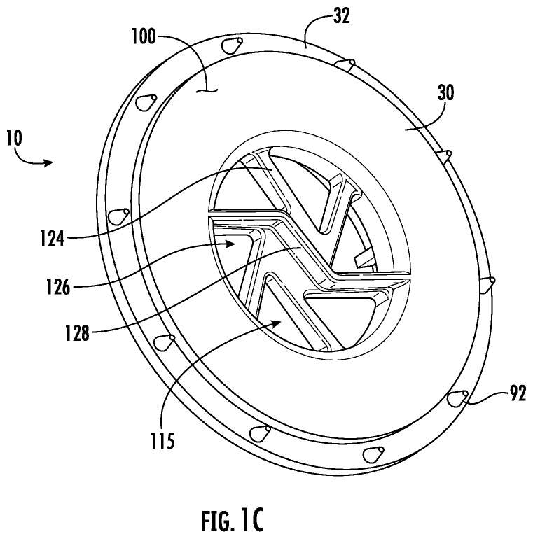

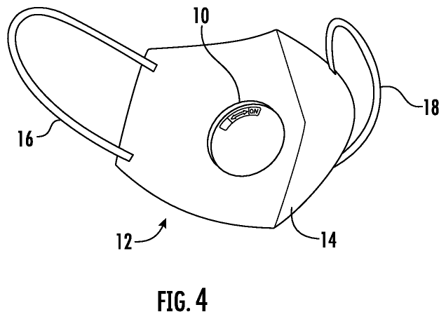

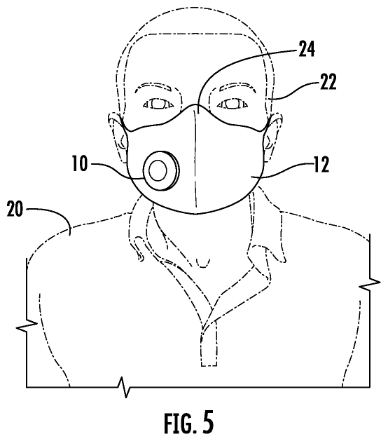

Referring to FIGS. 1A-3C, an illustrative embodiment of an air filtration mask exhalation valve with ON/OFF capability, referred to generally as exhalation valve 10, is illustrated. The exhalation valve 10 is designed to secure to an air filtration substrate or material that filters particulates in the air (filters or removes pathogens, small particles, vapors, etc.) passing therethrough. The exhalation valve 10 is designed to secure to an air filtration mask, such as cloth face masks, such as N95 type masks or other cloth masks. Referring to FIG. 4, an air filtration mask 12 with exhalation valve 10 is shown. The air filtration mask 12 is shown having a main body 14 sized and shaped to cover a human's head with bands 16 and 18 for securing to the wearer's ears. The exhalation valve 10 may be secured to, preferably removably secured to, the main body 14. Referring to FIG. 5, the air filtration mask 12 with exhalation valve 10 is shown secured to, or worn by an individual 20, so the air filtration mask 12 rests on the wearer's head 22, covering a portion of his/her nose 24 and mouth (covered by the air filtration mask 12).

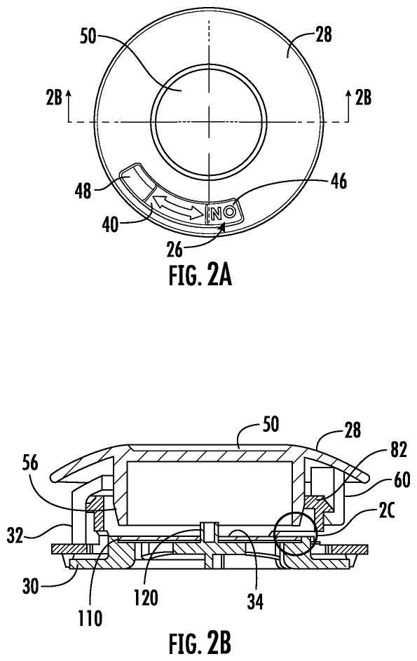

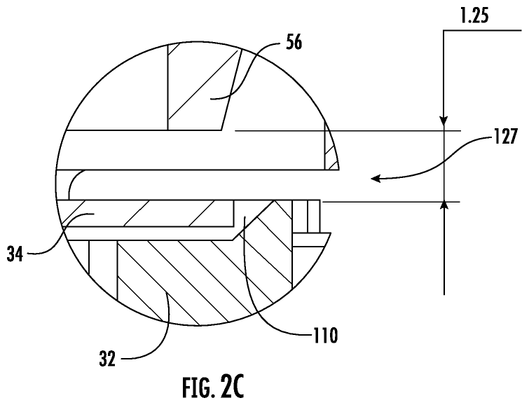

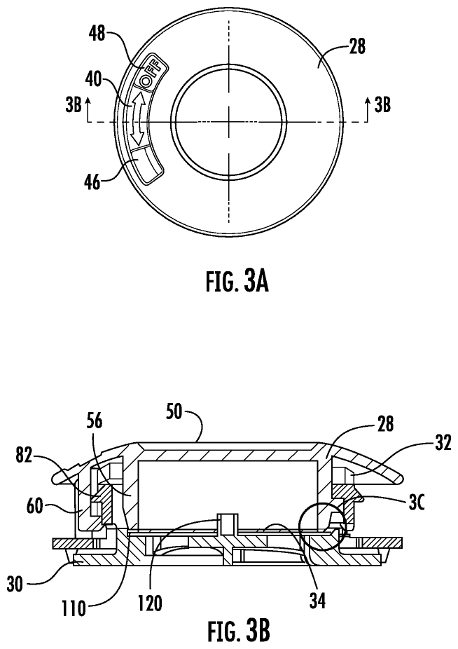

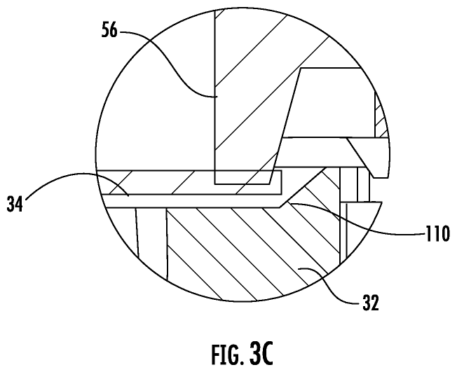

The exhalation valve 10 is designed to traverse, i.e. be moved between an ON (or OPEN; valve open -viewer hazard) position (FIG. 2A) and an OFF (or CLOSED; valve closed -viewer safe) position (FIG. 3A). When the exhalation valve 10 is placed in the ON position, see FIGS. 1A-2B, exhaled air is allowed to be quickly ventilated from inside the air filtration mask 12, thus forming the healthiest environment for the wearer. When the exhalation valve 10 is moved to an OFF position, see FIG. 3A, exhaled air cannot escape through the exhalation valve 10 and must pass through the air filtration main body 14 of the air filtration mask 12, thus protecting those in close proximity to the wearer from any possible contagion in the wearer's exhaled air. To indicate the status of the exhalation valve 10 to individuals around the mask wearer, the exhalation valve 10 may include a status window 26, see FIG. 2A. Within the status window 25, status (or position) indicators, such as the wording “ON” or “OFF” may be used. Alternative status indicators, such as colors, red for ON position or green for OFF position, may be used. In this manner, individuals near the user can easily and visually determine if the air filtration mask 12 worn by the user is allowing air to be moved out of the exhalation valve 10 (non-filtered air, possible microbial contamination) or air is not being moved through the exhalation valve 10, but only through the mask 12 (filtered air, non (or reduced) microbial contamination).

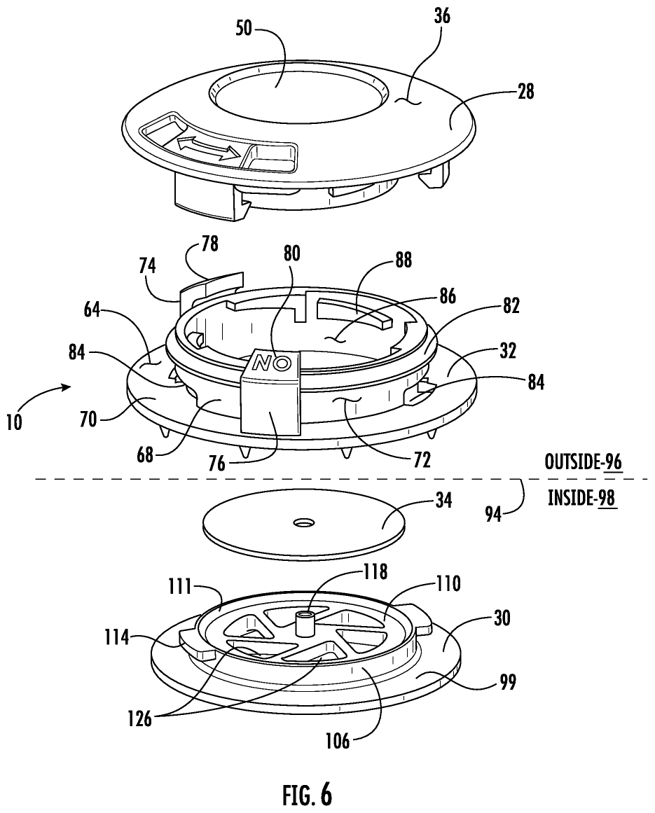

The exhalation valve 10 may comprise multiple components, some of which may be positioned on the outside of the air filtration mask 12, i.e. the surface not in contact with the wearer's face when being worn), and some being positioned on the inside of the air filtration mask 12, i.e. the surface in contact with the wearer's face when being worn. Referring to FIGS. 6-8, several exploded views of the exhalation valve 10 are provided. The exhalation valve 10 may comprise an upper component or member 28, illustrated herein as a valve cap, a lower component or member 30, illustrated herein as a valve base, an intermediate component or member 32 positioned in between the valve cap 28 and the valve base 30, and an air passage component or member 34, illustrated herein as a diaphragm valve, which sits within the intermediate component or member 32.

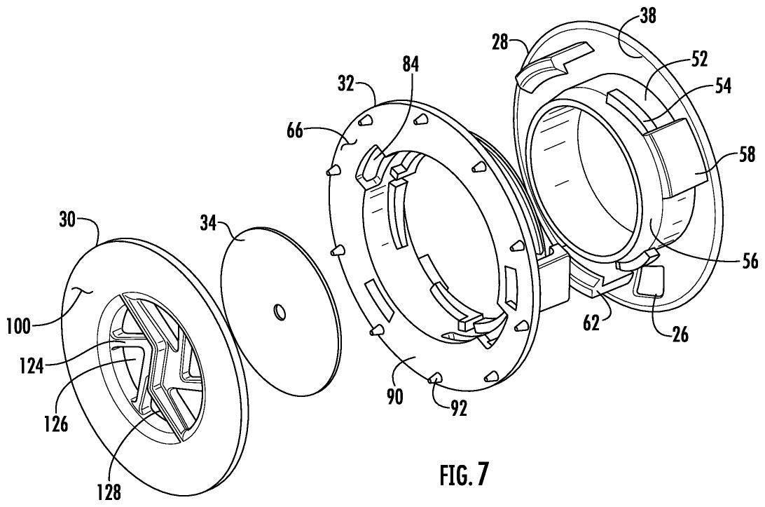

The valve cap 28 comprises an outer surface 36 (see FIG. 6) and an inner surface 38, see FIG. 7). The outer surface 36 may comprise a rotation indicator 40, shown as a plate 42 with a double arrow indicator 44 (see FIG. 8). The rotation indicator 40 may be placed within the indicator window 26, separating it into an ON-label window 46 and an OFF-label window 48. Depending on the direction of rotation, the ON label window 46 will show or display the word “ON” to indicate to third persons (i.e. not the person wearing the mask) that the exhalation valve 10 of the air filtration mask 12 is in the ON position. Upon rotating the exhalation valve 10 in the opposite direction, the OFF-label window will show or display the word “OFF” to indicate to third persons that the exhalation valve 10 of the air filtration mask 12 is in the OFF position. The outer surface 36 may include a removable plate 50. The removable plate 50 may be configured to snap fit within a portion of the outer surface 36.

The valve cap inner surface 38 comprises an upper body 52, shown as a ring structure extending downwardly, away from the inner surface 38. The inner surface upper body ring structure 52 comprises one or more cap ridges 54. Extending from the inner surface upper body ring structure 52 is a valve seal ring 56. In operation, the valve seal ring 56, when the exhalation valve 10 is rotated to the OFF position, acts to prevent the diaphragm valve 34 from moving, thus preventing air from being expelled out from the exhalation valve 10. The valve cap inner surface 38 may also include one or more cap snaps 58. The cap snaps 58 may comprise an elongated body 60 which extends downwardly, away from the inner surface 38 and terminates in a hook shaped end 62. The hook shaped ends 62 are directed inwardly, or facing the valve seal ring 56, and may be designed to engage with a portion of the intermediate component or member 32.

The intermediate component or member 32 comprises an outer surface 64 and an inner surface 66. The intermediate component or member 32 may further contain an inner component 68, illustrated as an inner ring, and an outer component 70, illustrated as an outer ring shaped plate. The outer ring shaped plate 70 may act as a stabilizing plate. This stabilizes the exhalation valve 10 against the outer fabric of the air filtration mask 12 and prevents leaks. It may also provide slots for the valve base 30 to screw into. Positioned along the outer surface 72 of the inner ring 68 is an OFF indicator stand 74 and an ON indicator stand 76. The upper surface 78 of the OFF indicator stand 74 contains the word “OFF” and is positioned to align with the OFF-label window 48 of the valve cap 28. The upper surface 80 of the ON indicator stand 76 contains the word “ON” and is positioned to align with the ON label window 46 of the valve cap 28. In addition to being used as position identifiers, both the OFF indicator stand 74 and the ON indicator stand 76 may function as stops, preventing over-rotation of the valve cap 28 in the ON and OFF movement. When the rotation reaches the OFF indicator stand/rotation stop 74, the valve seal ring 56 bottoming on the valve occurs simultaneously, stopping the rotation as well. When reaching the ON indicator stand/rotation stop 76, the ON indicator stand/rotation stop 76 helps terminate rotation as well. The inner ring 68 may also contain a snap ridge 82 which engages with the cap snaps 58. The snap ridge 82 extends around the perimeter of the inner ring 68. A plurality of screw tab slots 84 are formed in a portion of the inner ring 68 and the outer ring shaped plate 70. The plurality of screw tab slots 84 are sized and shaped to engage with the screw tabs 114 of the valve base 30 to allow the screwing of the valve base 30 into the intermediate component or member 32, assembling the exhalation valve 10 into the air filtration mask 12.

Positioned within the inner surface 86 of the inner ring 68 are one or more directional rotation members 88, illustrated herein as up/down rotation helix or spiral shaped bodies. The up/down rotation helix or spiral shaped bodies 88 function when the one or more cap ridges 54 rides along the rotation member 88, allowing the valve cap 28 to move up to open, and down to close, when rotated.

Positioned around the perimeter of the inner surface 90 of the outer ring shaped plate 70 are one or more retaining members 92, illustrated herein as cleats or spikes 92. The one or more retaining member cleats or spikes 92 are sized and shaped to secure to the air filtration mask 12 fabric or material, securing the intermediate component or member 32 thereto. The one or more retaining member cleats or spikes 92 prevent the intermediate component or member 32 and the valve base 30 from moving when the user rotates the valve cap 28 between the ON position and the OFF position. They also function to prevent the intermediate component or member 32 from rotating when the valve base 30 is screwed into the intermediate component or member 32. This ensures that the ON/OFF labels 46 and 48 on the intermediate component or member 32 stay in the position to the top of the air filtration mask 12 during assembly of the valve base 30 to the intermediate component or member 32/valve cap 28 assembly.

When secured to the filtration mask 12, the valve cap 28 and the intermediate component or member 32 are positioned on the outside, see broken line 96 (FIGS. 6 and 8), providing a divider indicator and demarcation components on the outer surface or portion 96 of the air filtration mask 12 and those components on the inner surface 98 or portion of the air filtration mask 12. The valve base 30 and the diaphragm valve 34 are located or positioned on the inner surface or portion 98.

The valve base 30 comprises an outer member 99 having an outer surface 100 and an inner surface 102 (portion of which may form an inner stabilizer plate), see FIGS. 6 and 8. Extending upwardly, away from the inner surface 102 is a continuous wall or surface 104 forming a ring 106. The interior portion 108 of the ring 106 forms a valve seat 110 sized and shaped to receive and hold therein the diaphragm valve 34. The upper end 112 of the ring 106 forms a valve seat ridge 111. Oppositely positioned, shown 180 degrees apart, are base valve screw tabs 114 and 116. The purpose of the base valve screw tabs 114 and 116 are to allow connection of the valve base 30 to the intermediate component or member 32 by a screwing action. Extending upwardly, away from the inner surface 102, preferably centrally positioned, is a valve stabilizing stem 118. The valve stabilizing stem 18 has an elongated body 120, terminating in an opening 122. The valve base 30 may also comprise a center area having one or more valve supports 124. Cut out portions forming air flow ports 126 function to allow air to flow through the valve base 30 when the wearer exhales and the exhalation valve 10 is in the ON position. The diaphragm valve 34 is then free to move since it is preferably made of silicone, allowing the outer edges to push out and the air to pass through the exhalation valve 10 by passing between a space or gap 127 (see FIG. 2C) between the valve cap 28 and the intermediate component or member 32. A screw handle 128 provides a place for the wearer's fingers to grab the valve base 30 to screw it into the intermediate component or member 32. The screw handle 128 may extend away from base valve seat 110 and extend the length of the diameter of opening 115. As shown, the screw handle 128 contains portions which are bent or angled relative to adjacent portions. The valve cap 28 may, but need not, be provide pre-assembled, snapped into the intermediate component or member 32.

The diaphragm valve 34 may be made of an elastic material and is sized and shaped to sit within the base valve seat 110. As illustrated, the diaphragm valve 34 has a circular body 132 having a centrally positioned aperture, referred to herein as a valve connection aperture 134. The valve connection aperture 134 is sized and shaped to fit over the valve stabilizing stem 118. When in the ON position, the diaphragm valve 34 is designed to rest within the base valve seat 110 when a user inhales, thus preventing air from entering into the air filtration mask 12 via the exhalation valve 10. When a user exhales, the diaphragm valve 34 may move off this position in order to let air travel out of the air filtration mask 12, through the exhalation valve 10. When in the OFF position, the valve seal ring 56 of the valve cap 28 is aligned to push and maintain the diaphragm valve 34 to the base valve seat 110. In this position, the diaphragm valve 34 is unable to move when a user exhales, thus preventing air from exiting through the exhalation valve 10. In this case, air may only be moved out through the filtering body 14 of the air filtration mask.

The exhalation valve 10 may be permanently placed within the air filtration mask 12. Alternatively, the exhalation valve 10 may be removably placed within the air filtration mask 12 so the exhalation valve 10 may be recycled and used in a new air filtration mask 12. The exhalation valve 10 may be assembled in a sequence in which first the diaphragm valve 34 is inserted into the intermediate component or member 32, particularly within the valve seat 110. The diaphragm valve 34 is held in place by the valve connection aperture 134, fitting snugly to the valve stabilizing stem 118 in the valve base 30

The valve base 30 is then inserted into the air filtration mask 12 from the inside of the mask. The base valve screw tabs 114 and 116 on the valve base 30 hold the mask fabric below the base valve screw tabs 114 and 116 while the outer ring shaped plate 70 is attached to the valve base 30, aiding assembly. This is done by placing the outer ring shaped plate 70 onto the valve base 30 from outside the mask while aligning the base valve screw tabs 114 and 116 with the screw tab slots 84 on the outer ring shaped plate 70. The outer ring shaped plate 70 may be held firmly in position on the outer mask fabric by the one or more fabric retaining member cleats 92 as the valve base 30 is screwed into the outer ring shaped plate 70. This prevents the outer ring shaped plate 70 and valve cap 28 from rotating when the valve base is screwed so the position of the ON/OFF labels 46 and 48 can maintain their orientation to the top.

The screw handle 128 located on the bottom of the valve base 30 is formed by an extension of two of the valve supports 124. The screw handle 128 allows for ease in holding and turning the valve base 30 during assembly. The valve supports 124 hold the exhalation valve 10 firmly in position. Air flow ports 126, positioned between the valve supports 128, allow air to flow freely through the assembly when the exhalation valve 10 is open. The valve supports 128 also provide strength to the valve base 30.

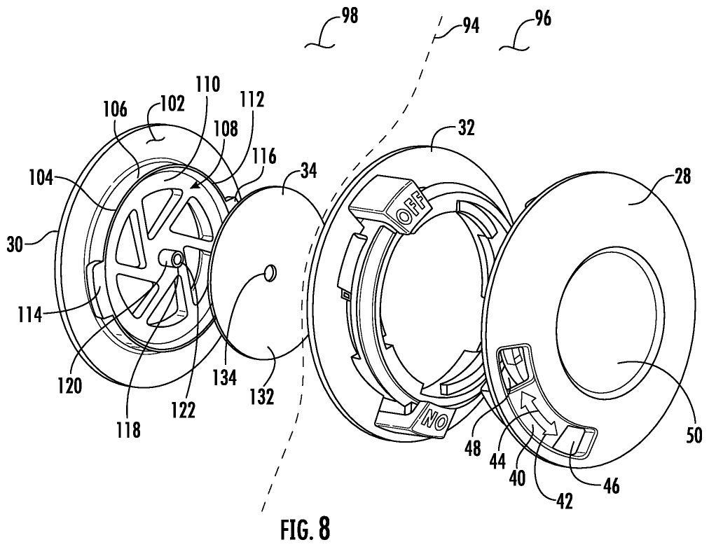

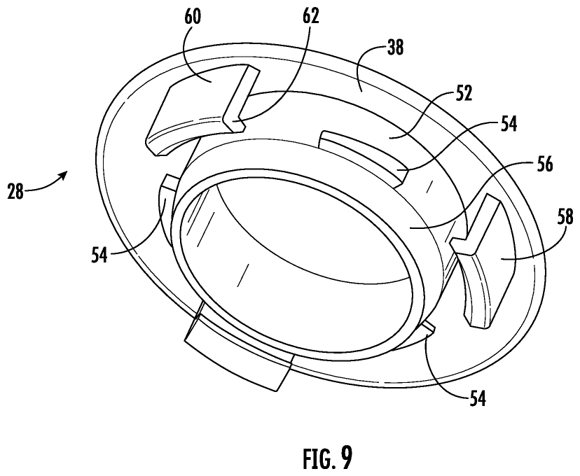

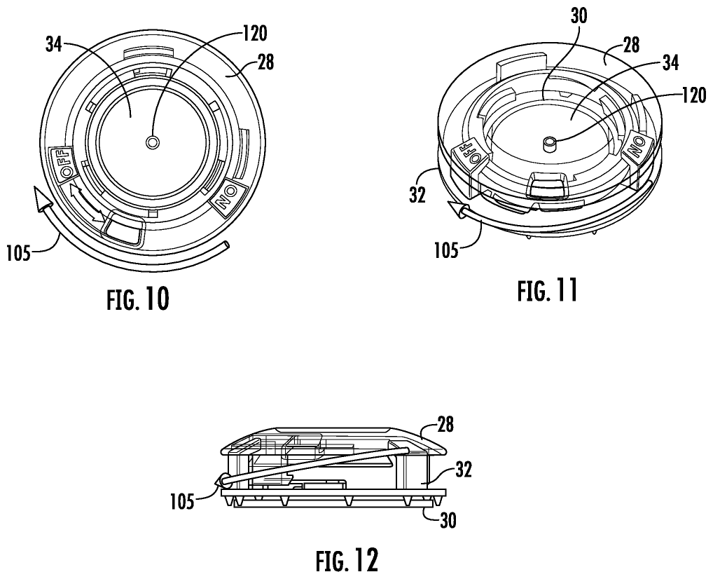

The valve cap 28 may be attached to the outer ring shaped plate 70 by the cap snaps 58 snapping over the snap ridge 82 on the outer ring shaped plate 70, thus forming an assembly. The valve cap 28 is then free to rotate on the outer ring shaped plate 70 with the one or more cap ridges 54 riding on an up/down rotation helix (one or more directional rotation members 88, illustrated herein as up/down rotation helix body) located inside the outer ring shaped plate 70. The valve seal ring 56 is formed from an extension of the valve cap 28. The valve cap 28 is rotated down on the helix 88 by rotating the valve cap 28 clockwise on the intermediate member 32 until it rests on the outer edge of the diaphragm valve 34 (see FIGS. 10-12, arrow 105 representing the direction of rotation of the valve cap 28). The valve seal ring 56 then presses the diaphragm valve 34 against the base valve seat 110 of the valve base 30, closing the exhalation valve 10 so no air can flow through the exhalation valve 10 when the wearer exhales. At the same position, the cap snap 58 has pressed against the OFF indicator stand/rotation stop 74, ending the rotation. The OFF label 78 on the top of the OFF indicator stand 74 can then be seen through the OFF label window 48 in the valve cap 28.

The valve cap 28 can then be rotated counterclockwise to open the exhalation valve 10, with the one or more cap ridges 54 running up the helix 88 until the cap snap 58 hits the ON indicator stand 76. The ON label 80 on the top of the ON indicator stand 76 can then be seen through the ON label window 46 in the valve cap 28. As the valve cap 28 rides up the helix 88, the seal ring 56 moves off the diaphragm valve 34, so the diaphragm valve 34 is free to open along the edges so the air can flow through the air flow ports 126 and between a gap created between valve cap 28 and the top of the outer ring shaped plate 70. Gaps may be added to inner surface upper body ring structure 52. As the wearer exhales, the force of the air opens the diaphragm valve 34 away from the valve seat 110 so the exhaled air can pass out of the exhalation valve 10 quickly when they exhale. Removing the exhaled air quickly helps reduce the chance of the wearer breathing back in their previously exhaled air possibly trapped inside the air filtration mask 12. While in the ON position, the diaphragm valve 34 closes against the valve seat 110 when the wearer inhales due to the suction against the diaphragm valve 34. This forces the inhaled air through the filtering portion of the air filtration mask 12. The wearer then can adjust the exhalation valve 10 from the ON position to the OFF position based on the situation. The screw assembly feature allows the valve to be moved from mask to mask.

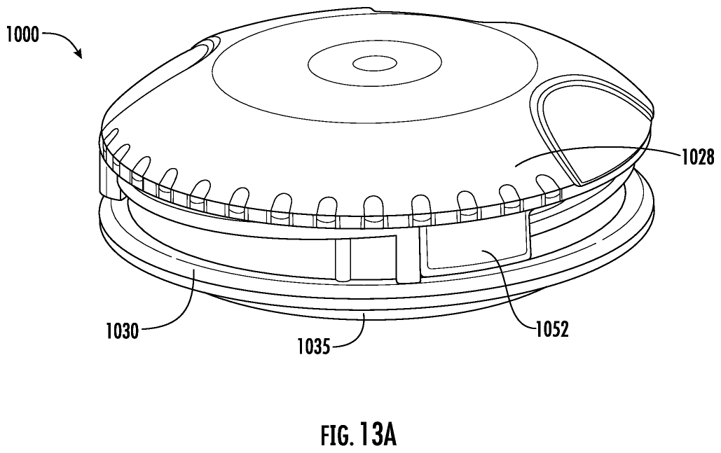

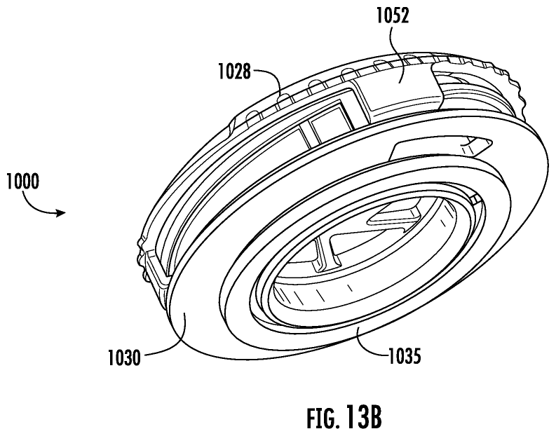

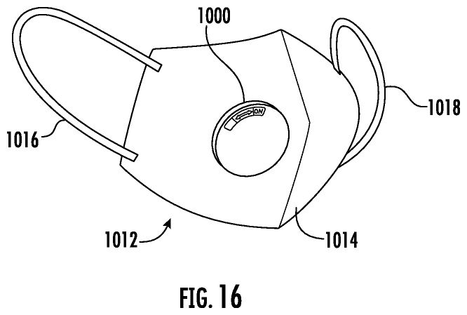

Referring to FIGS. 13A-15C, an illustrative embodiment of an air filtration mask exhalation valve with ON/OFF capability, referred to generally as exhalation valve 1000, is illustrated. The exhalation valve 1000 is designed to secure to a substrate or material that filters particulates in the air (filters or removes pathogens, small particles, vapors, etc.) passing therethrough. The exhalation valve 1000 is designed to secure to an air filtration mask, such as cloth face masks, such as N95 type masks or other cloth masks. Referring to FIG. 16, an air filtration mask 1012 with exhalation valve 1000 is shown. The air filtration mask 1012 is shown having a body 1014 sized and shaped to cover a human's face, or portions thereof, with bands 1016 and 1018 for securing to the wearer's ears. The exhalation valve 1000 may be secured to, such as removably secured to, the mask body 1014. Alternatively, the exhalation valve 1000 may be fixed to the mask body 1014 via sonic welding.

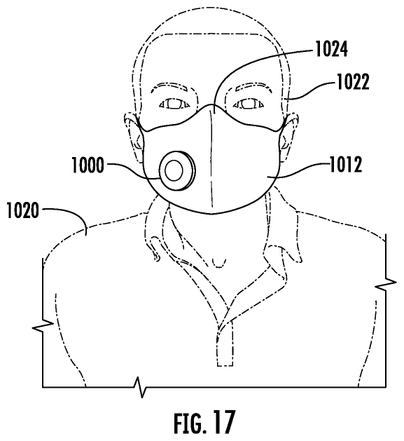

Referring to FIG. 17, the air filtration mask 1012 with exhalation valve 1000 in an air filtration mask 1012 is shown secured to, or worn by an individual 1020, so the air filtration mask 1012 rests on portions of the wearer's face 1022, or portions thereof, covering a portion of his/her nose 1024 and mouth (covered by the air filtration mask 1012).

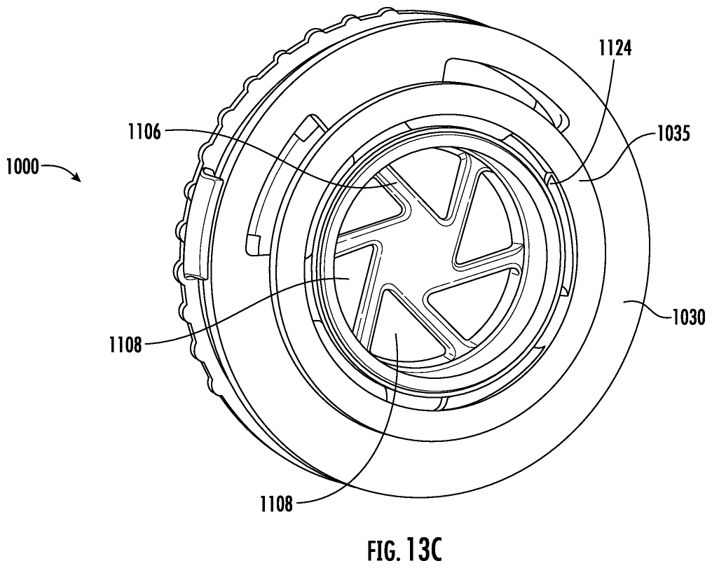

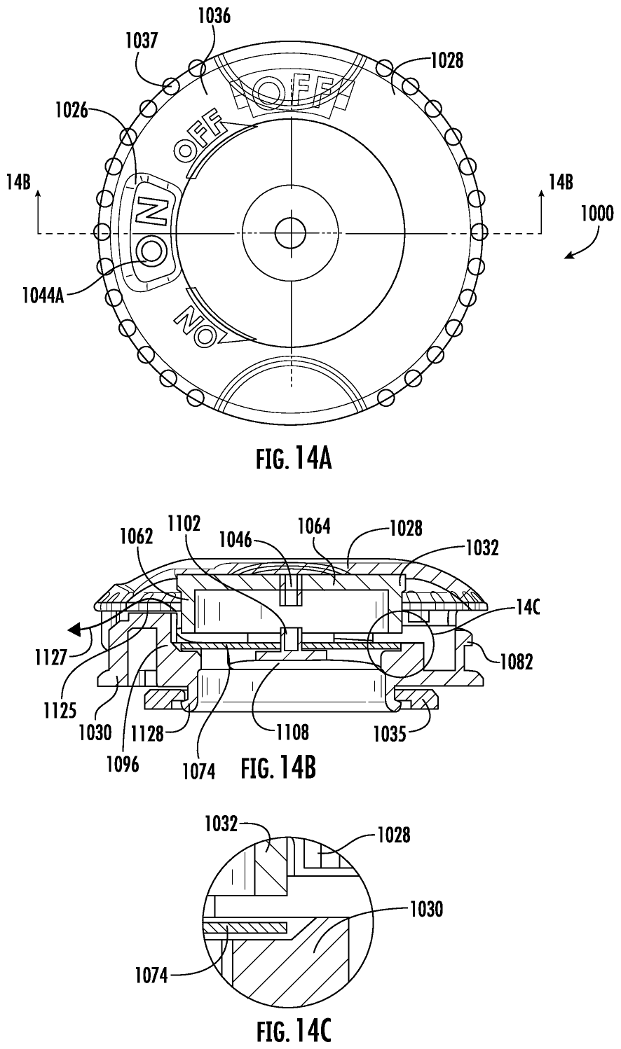

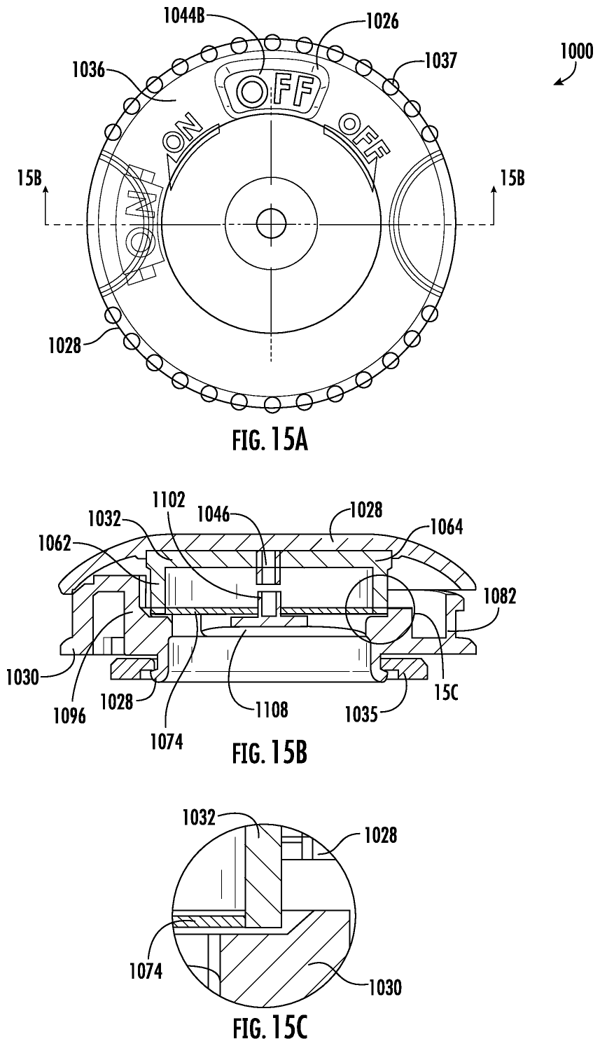

The exhalation valve 1000 is designed to traverse, i.e. be moved, between an ON position (FIG. 14A) and an OFF (or CLOSED; valve closed -viewer safe) position (FIG. 15A). When the exhalation valve 1000 is placed in the ON position, see FIGS. 14A-14C, exhaled air is allowed to be quickly ventilated from inside the air filtration mask 1012, thus forming the healthiest environment for the wearer. When the exhalation valve 1000 is moved to an OFF position, see FIGS. 15A-15C, exhaled air cannot escape through the exhalation valve 1000 and must pass through the air filtration main body 1014 of the air filtration mask 1012, thus protecting those in close proximity to the wearer from any possible contagion in the wearer's exhaled air. To indicate the status of the exhalation valve 1000 to individuals around the mask wearer, the exhalation valve 1000 may include a status window 1026, see FIG. 14A or FIG. 15A (figures shown in a transparent view to better illustrate the ON/OFF indicator structure). Within the status window 1026, status (or position) indicators, such as the wording “ON” (FIG. 14A) or “OFF” (FIG. 15A) may be used. Alternative status indicators, such as colors, red or yellow for ON position or green for OFF position, may be used. In this manner, individuals near the user can easily and visually determine if the air filtration mask 1012 worn by the user is allowing air to be moved out of the exhalation valve 1000 (non-filtered air, possible microbial contamination) or air is not being moved through the exhalation valve 1000, but only through the mask 1012 (filtered air, non (or reduced) microbial contamination).

The exhalation valve 1000 may comprise multiple components, some of which may be positioned on the outside of the air filtration mask 1012, i.e. the surface not in contact with the wearer's face when being worn), and some being positioned on the inside of the air filtration mask 1012.

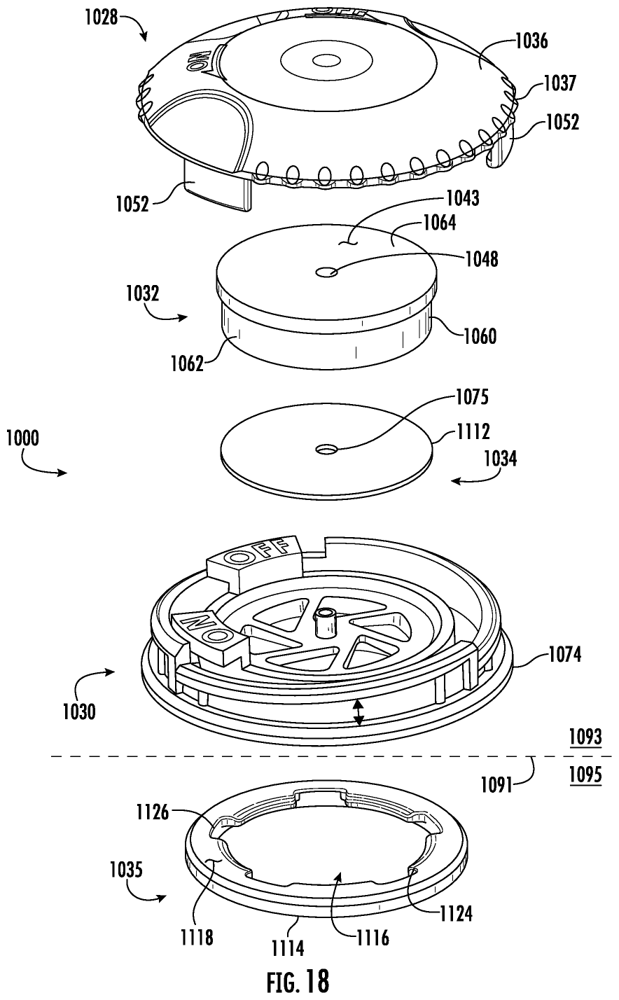

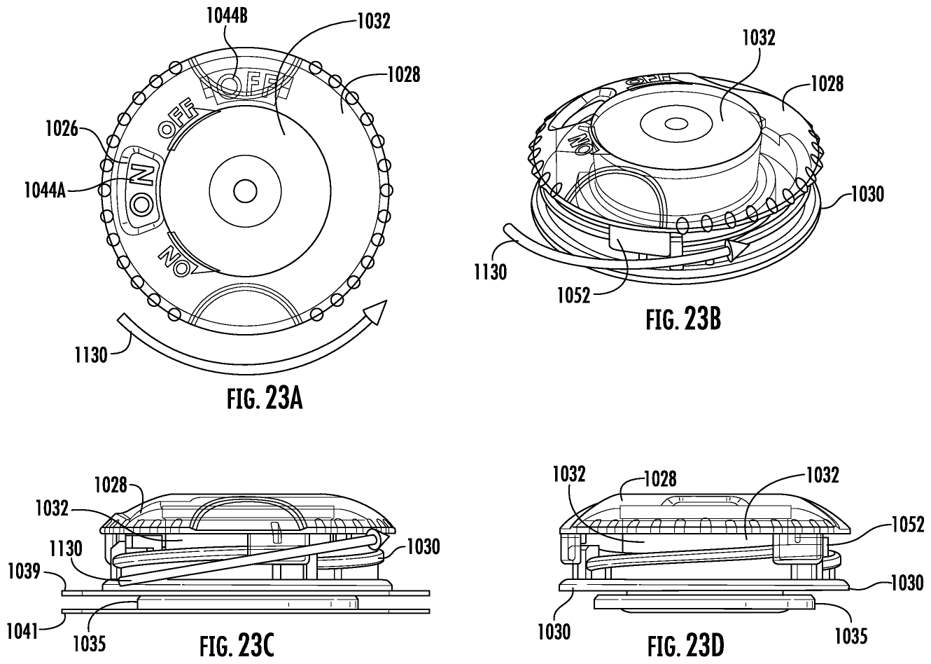

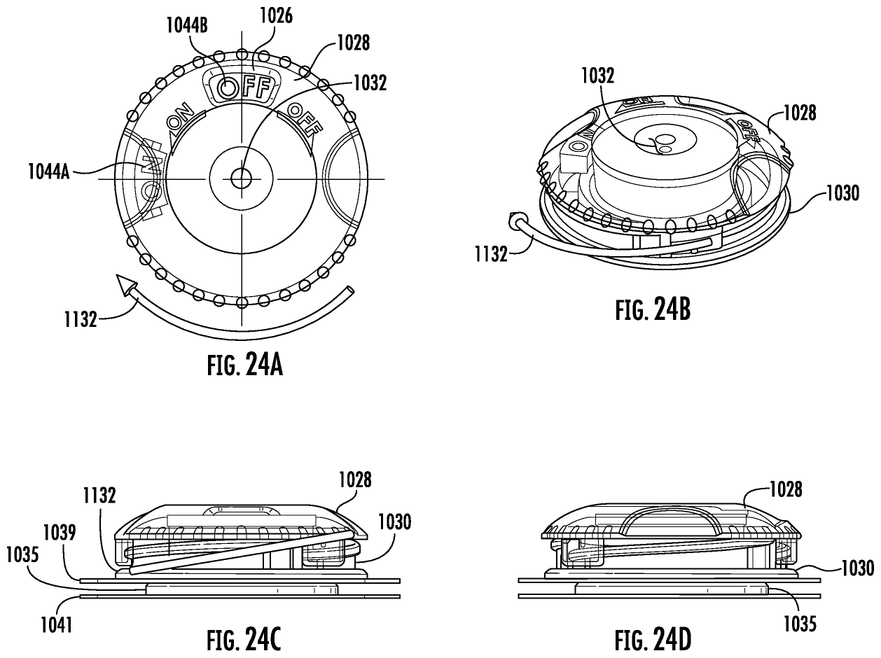

Referring to FIGS. 18-20, exploded views of the exhalation valve 1000 are provided. The exhalation valve 1000 may comprise an upper component or member 1028, illustrated herein as a valve cap, a lower component or member 1030, illustrated herein as a valve base, an intermediate component or member 1032, illustrated herein as an inner cap positioned in between the valve cap 1028 and the valve base 1030, an air passage component or member 1034, illustrated herein as a diaphragm valve which sits within the valve base 1030, and a filter substrate engagement member 1035, illustrated herein as a filter snap. The filter snap 1035 is welded to a filter 1041 (FIG. 23C or 24C) to allow other portions to snap onto it. In use, the filter snap 1035 may also allow the exhalation valve 1000 to secure to the filter 1041, and/or optionally to a mask fabric 1039, or to just a filter that is a filter and not cloth like an N95 mask. See FIGS. 23C, 23D, 24C, or 24D.

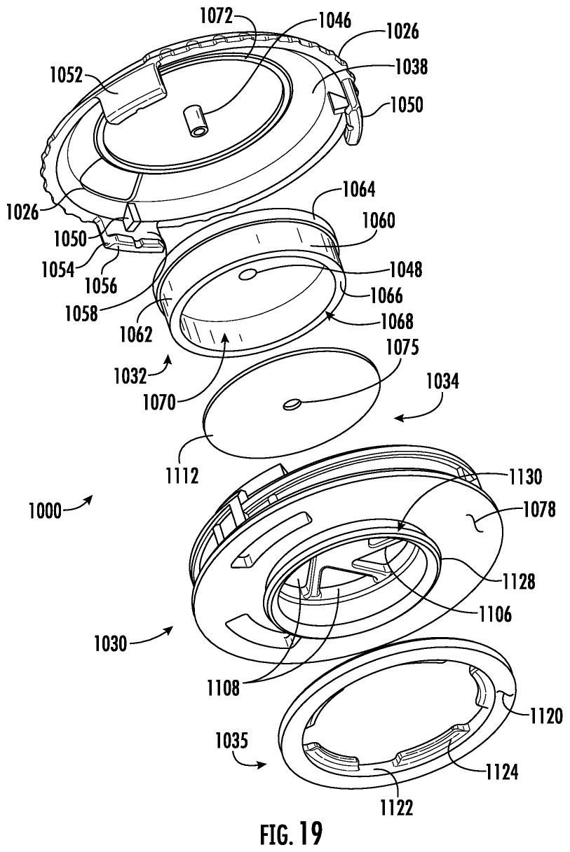

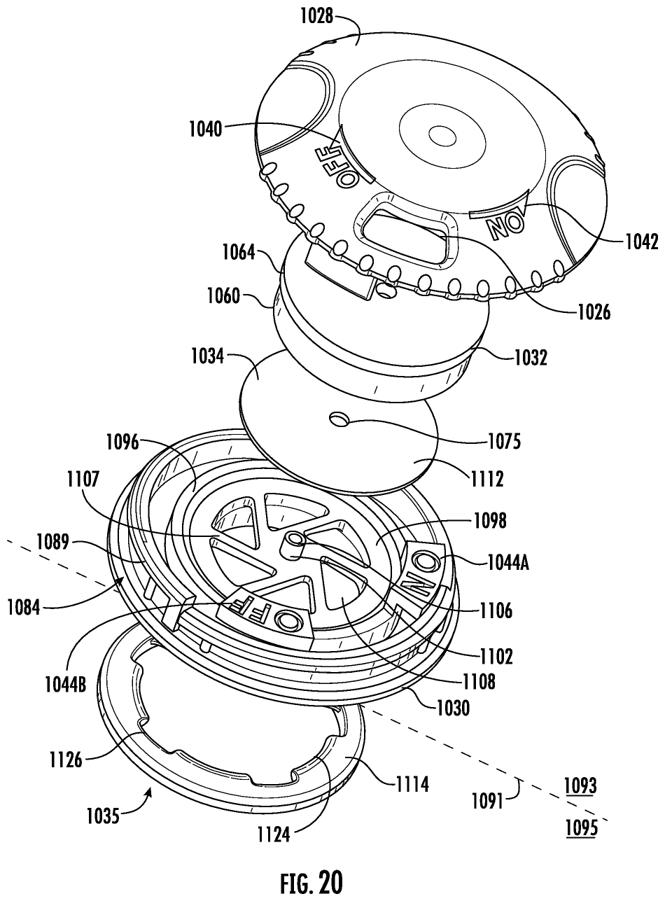

The valve cap 1028 comprises an outer surface 1036 (see FIG. 18) and an inner surface 1038, see FIG. 19). The outer surface 1036 may include a gripping surface 1037. The outer surface 1036 may comprise a rotation indicator, shown as a first arrow indicator 1040, see FIG. 20, designating the rotation direction for the OFF position, and a second arrow 1042, designating the rotation direction for the ON position. The rotation indicator 1040 may be placed near the window 1026. Depending on the direction of rotation, the window 1026 will show or display the “ON” indicator 1044A (See FIG. 20) to indicate to third persons (i.e. not the person wearing the mask) that the exhalation valve 1000 of the air filtration mask 1012 is in the ON position. Upon rotating the exhalation valve 1000 in the opposite direction, the window 1026 will show or display the “OFF” indicator 1044B (See FIG. 20) to indicate to third persons that the exhalation valve 1000 of the air filtration mask 1012 is in the OFF position.

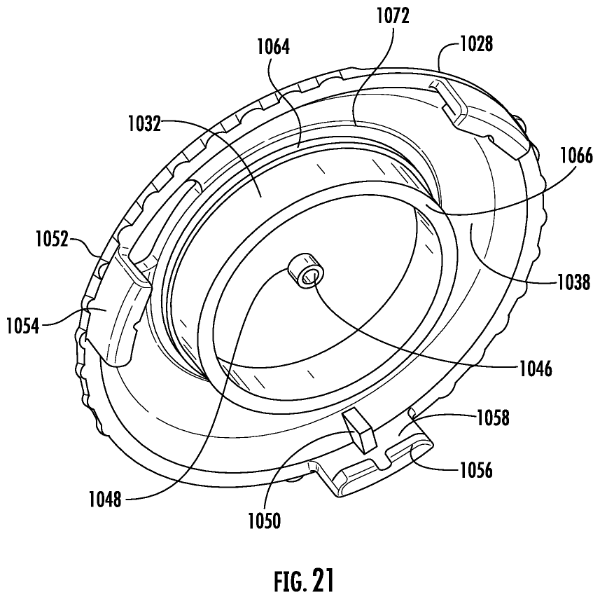

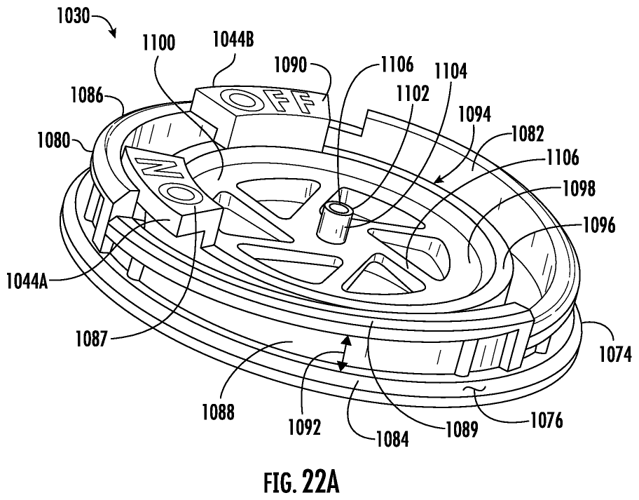

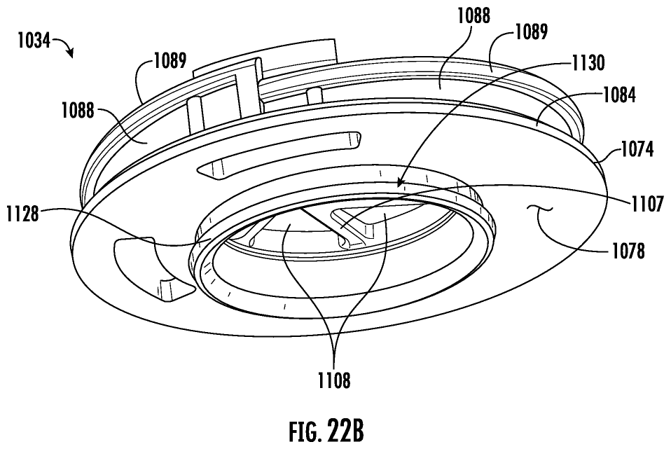

The valve cap inner surface 1038 comprises a valve cap alignment post 1046. The valve cap alignment post 1046 is sized and shaped to fit and rest within an inner cap opening 1048 located on going through a top surface 1043 of the inner cap 1032. The cap alignment post 1046 allows the inner cap 1032 to properly align and rest within the valve cap 1028, see FIG. 21. Although illustrated as two independent pieces fitting together, the valve cap 1028 and inner cap 1032 may be constructed as a single unit, preferably molded in one piece. The valve cap inner surface 1038 may also comprise one or more cap to base support structures 1050. The cap to base support structures 1050 are constructed and arranged to allow the valve cap 1028 to bind and secure to at least a portion of the valve base 1030. In combination with a hook shaped end 1056, the cap to base support structures 1050 hold the valve cap 1028 firmly to the valve base 1030. While three (3) cap to base support structures 1050 are shown equally spaced apart, two (2) or more than three (3) may be used. The valve cap 1028 may further include one or more cap to valve base support securing members 1052 extending away from the valve cap inner surface 1038. The cap to valve base support securing members 1052 may comprise an elongated body 1054 which extends downwardly, away from the valve cap inner surface 1038 and terminate in a hook shaped end 1056 located on an inner surface 1058. The hook shaped ends 1056 are directed inwardly, and are designed to engage with a portion of the valve base 1030 (specifically with snap fit ridge or overhang 1089, see FIG. 22B).

The inner cap 1032 may comprise a body 1060 having a continuous side wall 1062 in the shape of a ring, and an upper wall 1064. The bottom end 1066 has an opening 1068 exposing an interior 1070. Once inserted into the valve cap 1028, the upper wall 1064 may fit and secure within a valve cap ridge 1072 located on the valve cap inner surface 1038. The inner cap 1032 is secured within the valve cap 1028 via snap fitting, and further held in place via the valve cap alignment post 1046 being inserted into and through the inner cap opening 1048, see FIG. 21. The inner cap 1028 is preferably lightly secured to allow it to be free to rotate around the cap post 1046. This arrangement allows the inner cap 1028 to turn on the post cap post 1046, preventing the diaphragm valve 1034 from bunching.

The valve base 1030, see FIG. 22A or FIG. 22B, comprises a main body 1074 having a first or inner surface 1076, and a second or outer surface 1078. The valve base 1030 main body 1074 may further contain an inner component 1080 having a continuous inner wall 1082 shaped having a circular, or ring like, shaped ring. The inner wall 1082 may be set inwardly to provide an edge or flanged surface 1084, extending around the perimeter of the inner wall 1082. The bottom surface 1078 of the valve base 1030 may act as a stabilizing plate. This stabilizes the exhalation valve 1000 against the outer fabric of the air filtration mask 12 and prevents leaks. Positioned along an outer surface 1086 of the inner wall 1080 is the “ON” indicator 1044A and the “OFF” indicator 1044B. An upper surface 1087 of the ON indicator 1044A contains the word “ON” and is positioned to align with the window 1046 when the valve cap 1028 is rotated to the “ON” position. An upper surface 1090 of the “OFF” indicator 1044B contains the word “OFF” and is positioned to align with the window 1046 when the valve cap 1028 is rotated to the “OFF” position. In addition to being used as position identifiers, both the “ON” indicator 1044A and the “OFF” indicator 1044B may function as stops, preventing over-rotation of the valve cap 1028 in the ON and OFF movement. Alternatively, use of “ON” and “OFF” may be replaced with color indicators, such as a green color for “OFF”, indicating the viewer is safe and a yellow color for “ON” indicating the viewer may be in a potentially hazardous condition if the mask wearer has a transmissible illness.

The valve base main body 1074 may contain one or more cap to valve base support securing member receiving channels 1088. Each of the one or more cap to valve base support securing member receiving channels 1088 are constructed and arranged to receive a cap to base support securing member(s) 1052. In addition to receiving and being stored therein, the cap to base support securing member receiving channels 1088 are sized and shaped to allow the cap to base support securing member to move within, i.e. when the cap valve 1028 is rotated between the “ON” and “OFF” position or the “OFF” to “ON” positions. The cap to base support securing member receiving channels 1088 may be defined by a snap fit ridge or overhang 1089 of the inner wall 1082 at one end, the edge or flanged surface 1084 at a second end, and an opening 1092 therebetween defined by the inner wall 1082 being set back from the end surfaces of the snap fit ridge or overhang 1089 and the edge or flanged surface 1084. The snap fit ridge or overhang 1089 may be sized and shaped to engage with the cap to base support securing members elongated body hook shaped end 1056.

Additionally, the cap to base support securing member receiving channels 1088 are sized and shaped so that the distance between the snap fit ridge or overhang 1089 and the edge or flanged surface 1084 may be variable along the length of the channel 1088, i.e. smaller at one end, and greater at a second end.

The valve base main body inner wall 1082 encloses an interior 1094. The interior 1094 may include a secondary continuous inner wall 1096, assuming a generally circular or ring shape. The secondary inner wall 1096 encloses a valve seat 1098, illustrated herein as a generally planar wall or surface, sized and shaped to receive and hold therein the diaphragm valve 1034. Extending upwardly, away from the inner surface 1100 of the valve seat 1098, preferably centrally positioned, is a valve stabilizing stem 1102. The valve stabilizing stem 1102 has an elongated body 1104, terminating in an opening 1106.

The valve seat 1098 may also comprise a center area having one or more valve supports 1107. Cut out portions forming air flow ports 1108 function to allow air to flow through the valve base 1030 when the wearer exhales and the exhalation valve 1000 is in the ON position, see FIG. 20. The diaphragm valve 1034 is then free to move since it is preferably made of a pliable material silicone, allowing the outer edges to push out when forced by the exhaled air and the air to pass through the exhalation valve 1000 by passing between a space or gap 1125 (see arrow 1127 for air flow illustration, FIG. 14B) between the valve cap 1028 and the valve base 1030.

The diaphragm valve 1034 may be made of an elastic material and is sized and shaped to sit within the valve seat 1098. As illustrated, the diaphragm valve 1034 has a circular body 1112 having a centrally positioned aperture, referred to herein as a valve connection aperture 1075. The valve connection aperture 1075 is sized and shaped to fit over the valve stabilizing stem 1102. When in the ON position, the diaphragm valve 1034 is designed to rest within the base valve seat 1098 when a user inhales, thus preventing air from entering into the air filtration mask 12 via the exhalation valve 1000. When a user exhales, the diaphragm valve 1034 may move off this position in order to let air travel out of the air filtration mask 12, through the exhalation valve 1000. When in the OFF position, the inner cap 1032 is aligned to push and maintain the diaphragm valve 1034 to the base valve seat 1098. In this position, the diaphragm valve 1034 is unable to move when a user exhales, thus preventing air from exiting through the exhalation valve 1000. In this case, air may only be moved out through the filtering body 14 of the air filtration mask.

The filter snap 1035 provides connection of the valve base/assembly to an external filter 1041, see FIG. 24C, allowing the filter 1041 to be replaceable. The exhalation valve 1000 can be connected to filter 1041 in several ways. First, the exhalation valve 1000 can be connected to the replacement filter 1041 housed inside a cloth mask filter or fabric 1039, see FIG. 24C. The filter snap 1035 may be fastened by sonic weld or by other means to the outside of the filter 1041. The valve base 1030 snaps into the filter 1041. The valve base 1030 is fastened to the bottom of the valve base (1030). The filter 1041 can then be disposed and the valve assembly/mask snapped onto a new filter 1041 that has the snap pre-assembled. Second, the exhalation valve 1000 can be connected to a filter 1041 alone like an N95. The filter snap 1035 is sonic welded or by other means fastened to the outside of the filter 1041 then the valve base snaps into the filter 1041. The filter 1041 can then be disposed and the valve assembly snapped onto a new filter that has the snap pre-assembled. Alternately, the valve could be fastened to the filter without the snap piece but then the valve is not replaceable. In a third connection, the exhalation valve 1000 can be connected to a cloth mask without a replacement filter inside. The filter snap 1035 is fastened by sonic weld or other means to the outside of the cloth mask. Then the valve base snaps into the filter. The filter can then be disposed or laundered and the valve assembly replaced.

Referring to FIG. 18, 19, or 20, the filter snap 1035 comprises a main body 1114, illustrated herein as a circular body or ring, having an opening 1116. The main body 1114 has a first surface 1118 and a second opposing surface 1120. Located on an inner circumferential surface 1124 and arranged along the inner perimeter are one or more snap tabs 1124. Spaced in-between the one or more snap tabs 1124 are filter snap receiving areas 1126. The filter snap receiving areas 1126 are sized and shaped to snap into ridge 1130 on the valve base 1030. The filter snap 1035 attaches and secures to the bottom surface 1078 of the valve base 1030 at the filter snap attachment ridge 1128.

The exhalation valve 1000 may be permanently placed within the air filtration mask 12. Alternatively, the exhalation valve 1000 may be removably placed within the air filtration mask 12 so the exhalation valve 1000 may be recycled and used in a new air filtration mask 12. In use, the valve cap 1028 is free to rotate about the valve base 1030 via the cap to base support securing members 1052 moving directionally (within cap to valve base support securing member receiving channels 1088). Rotating the valve cap 1028 in a counter clockwise fashion, see arrow 1130, FIGS. 23A-23D, the exhalation valve 1000 is unlocked and is positioned in the “ON” position. In this position, air flows through the exhalation valve 1000, see arrow 1127, FIG. 14B. Rotating the valve cap 1028 in a clockwise fashion, see arrow 1132, FIGS. 24A-24D, the exhalation valve 1000 is locked and is positioned in the “OFF” position.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments.

Indeed, various modifications of the described modes for carrying out the invention which are obvious to those skilled in the art are intended to be within the scope of the following claims.

What is claimed is:

1. An exhalation valve for use with a substrate for filtering air comprising:
an upper member having an outer surface and an inner surface;
a lower member; and
an air passage member secured to said lower member,
said exhalation valve is configured to traverse between a first ON position and a second OFF position, wherein, said upper member or said lower member is rotatable, wherein rotation of said upper member or said lower members orientates said exhalation valve in said first ON position or said second OFF position.

2. The exhalation valve according to claim 1, wherein said exhalation valve further includes an intermediate member secured to said upper member.

3. The exhalation valve according to claim 1, wherein said exhalation valve further includes a filter substrate engagement member configured to secure said exhalation valve to a substrate.

4. The exhalation valve according to claim 1, wherein said filter substrate engagement member comprises a body configured to secure to said lower member.

5. The exhalation valve according to claim 1, wherein said exhalation valve further includes a substrate secured to said exhalation valve.

6. The exhalation valve according to claim 5, wherein said substrate is configured to filter air.

7. The exhalation valve according to claim 1, wherein said air passage member rests within said lower member.

8. The exhalation valve according to claim 7, wherein said air passage member is movable within said lower member.

9. The exhalation valve according to claim 1, wherein said air passage member is an elastic or pliable diaphragm.

10. The exhalation valve according to claim 1, wherein when said exhalation valve is placed in the ON position, air passes through said exhalation valve.

11. The exhalation valve according to claim 1, wherein when said exhalation valve is placed in the OFF position, air is prevented from passing through said exhalation valve.

12. The exhalation valve according to claim 1, wherein said exhalation valve includes a status indicator.

13. The exhalation valve according to claim 12, wherein said exhalation valve status indicator includes text, images, colors, or combinations thereof.

14. The exhalation valve according to claim 12, wherein said status indicator is a window within said upper member.

15. An air filtration device comprising:
a substrate configured to cover portions of a user's face and filter air,
an exhalation valve traversable between a first ON position, whereby air is passed through said exhalation valve, and a second OFF position, whereby air is prevented from passing through said exhalation valve, said exhalation valve comprising, an upper member having an outer surface and an inner surface, a lower member, and an air passage member secured to said lower member, said upper member or said lower member is rotatable; y secured together, wherein rotation of said upper member or said lower members orientates said exhalation valve in said first ON position or said second OFF position.

16. The air filtration device according to claim 15, wherein said exhalation valve further includes an intermediate member secured to said upper member.

17. The air filtration device according to claim 15, wherein said exhalation valve further includes a filter substrate engagement member configured to secure said exhalation valve to said substrate.

18. The air filtration device according to claim 15, wherein, said air passage member rests within said lower member.

19. The air filtration device according to claim 18, wherein, wherein said air passage member is movable within said lower member.

20. The air filtration device according to claim 15, wherein said exhalation valve includes a status indicator.

21. The air filtration device according to claim 20, wherein, wherein said exhalation valve status indicator includes text, images, colors, or combinations thereof.

22. The air filtration device according to claim 15, wherein said substrate is a mask or respirator.
